(19) United States
(12) Patent Application Publication
(10) Pub. No.: US 2020/0097916 A1
(43) Pub. Date: Mar. 26, 2020

(54) SYSTEM AND METHOD FOR PROVIDING ON-DEMAND EARLY WAGE DISPERSALS AGAINST ACRUED EARNINGS

(71) Applicant: Zayzoon Inc., Calgary (CA)

(72) Inventors: Tate Hunter Hackert, Comox (CA); Darcy Allan Tuer, Calgary (CA); Jamie Nghi Ha, Calgary (CA); Garth Andrew McAdam, Calgary (CA)

(21) Appl. No.: 16/137,889

(22) Filed: Sep. 21, 2018

(51) Int. Cl. G06Q 10/10; G06Q 20/28

(52) U.S. Cl. CPC G06Q 10/1053; G06Q 20/28

(57) ABSTRACT

A system is provided for providing automated early dispersals of accrued but unpaid wages to a worker who has accrued wages from one or more employers. The system includes one or more customizable applications associated with the system, a communications platform in the form of an application programming interface for integrating and communicating in real-time with one or more databases containing employment and accrued wages information, a processor and memory that stores instructions from each of the one or more customizable applications. The instructions, when executed by the processor, cause the processor to receive a request for an early dispersal of wages from the worker, communicate in real-time with the one or more databases via the applications programming interface to collect employment and accrued wages information of the worker, automatically determine an early dispersal amount, dispersing the early dispersal amount to the worker upon processing the early wage amount, informing the worker of the determined early dispersal amount and collecting, at a time of wage payment, the early dispersal amount and a fee for service. A method is further provided for providing automated early dispersals of accrued but unpaid wages to a worker who has accrued wages from one or more employers.

### FIELD OF THE INVENTION

The present invention relates to a system and a method for providing on-demand, instant early wage dispersals based on accrued earnings.

The system and method provide for early dispersals to worker bank accounts and to creditors, of amounts that workers request at any time in a pay cycle for early wage dispersals of accrued earnings.

### BACKGROUND OF THE INVENTION

A wage earner typically earns by working and recording time, typically by the hour or portion thereof worked. A salaried worker works usual working days and accumulates hours. They are typically paid every two weeks or sometimes weekly or monthly.

Contract workers, contractors or independent contractors (contractors) typically contract with trucking companies, construction companies or other companies acting as principal who have the main contract with the customer (or have a contract with an intermediary contractor as the case may be). Contractors are typically paid upon completion of the work required under their contract with their principal or after certain percentages or stages of work completion, or upon the occurrence of other events. Upon completion of a discrete job or portion of a job, it is common for contractors to invoice their principal (or be given an invoice or other record of work). For the purposes of this disclosure, principals of contractors can be considered employers.

Historically banks operated payroll divisions to calculate pay, calculate source deductions, and pay the net pay owed to workers. But typically and more recently payroll companies also known as payment service providers, service bureaus, payroll companies, payment providers or pay providers (payment providers) have performed this service. Payment providers, also called Professional Employer Organizations (or PEO's) are large and active. They make wage payments for many hundreds of employers to tens and hundreds of thousands of workers.

Typically, for an ordinary payday, an employer funds the overall worker payroll to a payroll provider a few business days in advance of “payday”. The payroll provider receives those funds and on payday, if the worker is an employee, pays source deductions to third parties such as taxing authorities and pays workers their pay net of such deductions i.e. their net pay.

As illustrated in FIG. 1, should an employee require or wish to receive accrued wages before the payday, then they must make such a request to the employer. The employer may or may not fulfill such a request and might not even be in a position to provide early wages, from a cash flow standpoint.

Prior art patents such as that to Dombroski et al. in U.S. Pat. No. 8,751,338 and to Palaniappan in U.S. Pat. No. 9,202,250 provide a system whereby a third party company facilitates wage dispersals, however it does no more than facilitate and the employer pays the wage dispersals and later “balances the books”. The third party company may provide a convenient means for the worker to receive the wage dispersals from their employer, but funds are not from a third party and not without the numerous disadvantages of the employer's involvement.

### SUMMARY OF THE INVENTION

A system is provided for providing automated early dispersals of accrued but unpaid wages to a worker who has accrued wages from one or more employers. The system comprises one or more customizable applications associated with the system; a communications platform in the form of an application programming interface for integrating and communicating in real-time with one or more databases containing employment and accrued wages information about the worker; a processor; and memory that stores instructions from each of said one or more customizable applications. The instructions, when executed by the processor, cause the processor to perform operations comprising receiving a request for an early dispersal of wages from the worker; communicating in real-time with any one or more of the one or more databases via the applications programming interface to collect employment and accrued wages information of the worker; automatically determining an early dispersal amount based on employment and accrued wages information and meeting one or more pre-determined requirements; instantly dispersing the early dispersal amount to the worker upon processing the early wage amount; instantly informing the worker of the determined early dispersal amount; and collecting, at a time of wage payment, the early dispersal amount and a fee for service.

A system is further provided for providing automated early dispersals of accrued but unpaid wages to a worker who has accrued wages from one or more employers. The system comprises one or more customizable applications associated with the system; a communications platform in the form of an application programming interface for integrating and communicating in real-time with one or more databases containing employment and accrued wages information about the worker; a processor; a memory that stores instructions from each of said one or more customizable applications. The instructions, when executed by the processor, cause the processor to perform operations comprising: receiving a request for an early dispersal of wages from the worker; communicating in real-time with any one or more of the one or more database via the applications programming interface to collect employment and accrued wages information of the worker, instantly upon receiving the request; automatically determining an early dispersal amount based on employment and accrued wages information and meeting one or more pre-determined requirements; dispersing at least a portion of the early dispersal amount to one or more payees approved by the worker; dispersing a remaining portion of the early dispersal amount to the worker; informing the worker of the determined early dispersal amount, the portion dispersed to the payee and the portion dispersed to the worker; and collecting, at a time of wage payment, the early dispersal amount and a fee for service.

A method is further provided for providing automated early dispersals of accrued but unpaid wages to a worker who has accrued wages from one or more employers. The method comprises the steps of: providing one or more customizable applications associated with the system, a communications platform in the form of an application programming interface for integrating with one or more databases containing employment and accrued wages information about the worker and a processor; receiving a request for an early dispersal of wages from the worker; communicating in real-time with any one or more of the one or more database via the applications programming interface to collect employment and accrued wages information of the worker, instantly upon receiving the request; automatically determining an early dispersal amount based on employment and accrued wages information and meeting one or more pre-determined requirements; instantly dispersing the early dispersal amount to the worker upon processing the early wage amount; instantly informing the worker of the determined early dispersal amount; and collecting, at a time of wage payment, the early dispersal amount and a fee for service.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

A further, detailed, description of the invention, briefly described above, will follow by reference to the following drawings of specific embodiments of the invention. The drawings depict only typical embodiments of the invention and are therefore not to be considered limiting of its scope. In the drawings:

FIG. 1 is a flow diagram of a prior art system in which requests by a worker for early wage dispersal are made directly to the employer and may be dispersed by a payment provider upon instruction from the employer;

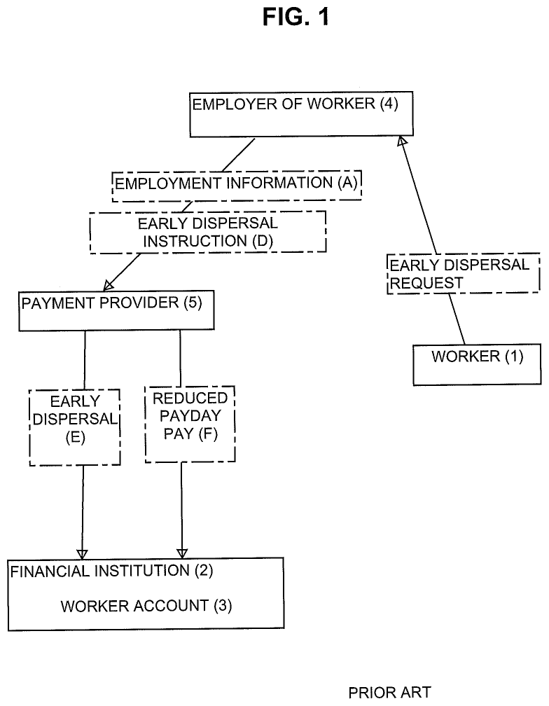

FIG. 2 is a flow diagram of one embodiment of the present invention;

FIG. 3 is a flow diagram of a further embodiment of the present invention, in which a worker is a contractor having multiple principals and multiple payment providers; and

FIG. 4 is a flow diagram of a further embodiment of the present invention, in which early wage dispersal may be transferred to a worker's financial institution and/or to an approved creditor.

### DETAILED DESCRIPTION OF THE PREFERRED EMBODIMENTS

This disclosure, its aspects and embodiments are not limited to the specific methods, devices and systems disclosed herein. Although particular systems and methods may be disclosed, the methods and systems of the present invention may be implemented in many forms known in the art for such systems and methods consistent with requirements of other financial accrued earnings dispersal operations. The figures and the following description illustrate specific exemplary embodiments of the invention. It will be appreciated by persons of skill in the art that other arrangements than those explicitly described or shown, embody the principles of the invention and are included in the scope of the invention

The inventive system provides software programs and particularly application program interface programs or API's and various means of data exchange and software integration to facilitate the tight exchange of information between third partys who may disperse early wages and payment providers. The system serves to integrate information from employers, payment providers and others who operate financial accounts for their customers with that of third parties who would provide responsive wage dispersal services, as well as actuating the interfacing of employers, payment providers and such third parties who may thereby become part of a system that works together for funding wage dispersals against accrued earnings quickly and seamlessly.

Embodiments of the present invention provide systems and methods by which a third party financial company can sustainably disperse funds from its own resources to workers who have worked and accrued wages and, to contractors who have provided work towards completing jobs entitling them to contract payments, (which can also be referred to as accrued earnings) who are waiting for payday (or for a contract payment date, which is also a kind of payday) to be paid.

The system operates to provide early accrued earnings dispersals by third parties and upcoming contract payments (which is another kind of accrued earnings). The system does so quickly and conveniently with low enough risk to the third party that workers and contractors (who can both be referred to as workers) pay a favorably low fee for the earnings dispersals. Multiple earnings dispersals can be made in a given pay cycle period.

The system provides a fulsome and timely exchange of all relevant human resource and employment information between payment providers on the one hand, who receive process and store such information originally received from employers and principals, with third parties who operate systems to receive and evaluate such information to make early wage dispersals, on the other.

The integration between the payment providers and third parties may be very close and supported by Application Programming Interface (API) for real time exchange.

Further the system may provide for workers to provide employment information directly to third parties so that it may be utilized by the third party in providing the financial service.

The system may use a recipe of considerations the third party would use to ensure the maximum amount of funds are dispersed that, along with other earnings dispersals in a given pay period, are able to be repaid on payday based on expected pay or net pay and for allowing the third parties to earn fees sufficient to cover costs and occasional default in repayment.

The inventive system may provide tight integration of employment information including start date, vacation and sick days, hourly rates and history of payday pay over a period of time, along with other employment and human resource information, between the payment provider and the third party.

The inventive system may also provide for situations in which workers work for several employers or principals and means for calculating accrued earnings on a cumulative basis and for ensuring the repayment of any early dispersals thereof, across several employers or principals. The system provides a means for the third party to give notice(s) to the payment providers associated with the one or more employers or principals, such notice(s) to include amounts dispersed and amounts to be paid to the third party.

The system may also facilitate, at the direction of a worker, the use of earnings dispersals as payments to creditors of the worker, such creditors to include ones providing necessaries of life such as home mortgage payments and ones providing discretionary goods and services such as the funding of financial investment accounts. The third parties may advise and provide systems whereby at any time, or at times when the worker is appearing to earn less than usual, the third party may prompt the worker and advise of its information about reduced earnings and whereby the worker may send instructions to the third party to pay bills and debts for necessaries of life such as a house mortgage, effecting a reduced spend by the worker on discretionary goods and services such as deposits to an investment account.

In the inventive system or method, the third party may be rewarded for advancing funds against worker requests by being paid a service fee in an amount that does or does not vary with the amount of the dispersal. The amount may vary in direct correlation to the amount of the dispersal. Preferably it is a set fee that does not vary, for appeal and simplicity. Preferably it is a modest fee that does not discourage workers to avail themselves of the system.

In the invented system the third party and the payment provider enter into an agreement which provides that upon making the wage dispersal(s) the third party advises the payment provider of the details of that and when it is payday, the payment provider splits out funds in a first amount being the amounts of that pay cycle's wage dispersal(s) and of any associated service fee amount(s) and a second amount being the worker's net pay for the relevant pay period. The system provides that the payment provider then transfers the split aligning with the dispersals and any fees, to the third party and the split aligning with the net pay, to the worker. Alternatively the service provider may treat the amount aligning with that pay cycle's wage dispersal(s) and of any associated service fee amount(s) as another deduction from pay to calculate net pay.

Upon a worker initiating a request for an earnings dispersal, the automated system of this invention will, upon receiving such request, using a system of computer hardware and software, and the exchange of data and information, in particular between payment provider on the one hand (which has the information of the employer as well as other information) and third party on the other, instantly confirm certain circumstances including worker's present employment or contractor status and accrued earnings. The system will evaluate the employment information and historical information between the worker and the third party and instantly arrive at a maximum amount of funds that may then be requested by the worker, advise the worker of the same, confirm what amount up to or less than that amount the worker desires will be dispersed, confirms that an imminent dispersal of same will instantly occur and automatically transfers such funds to the worker or worker account which may be a bank account or account worker controls which may be a bank account associated with a debit card.

The “Automated Clearing House” (ACH) is an organization and system for making payments operated by an association of financial institutions. The ACH payments system, along with debit cards and related bank accounts, credit cards, payment cards, e-wallet accounts and abundant services-access technology and infrastructure such as ATM's, and other financial system improvements have made it possible to conduct more varieties of financial transactions related to worker or contractor payments. However the present invention utilizes an aspect of a faster, newly-available payment system to process and disperse funds pursuant to wage dispersal requests immediately upon receiving them.

The early dispersal amount can then be dispersed to the worker 1 in any number of ways, either directly or indirectly by the third party, either instantly or in a deferred manner.

In one embodiment of the present invention the system uses the faster and almost instantaneous funds movement achieved using payment rails set up and utilized by real time payment service providers (RTPPs). Where individuals hold bank accounts associated with debit cards, RTPPs can fund money along such payment rails to such accounts as quickly as in less than a minute or sometimes ten to fifteen seconds time. In embodiments of the present invention the source of such funds include funds of the third party held in an account of the RTPP. The system may alternately provide a means to disperse via a check or e-check or other means of electronic funds transfer.

The present system permits third parties being able to provide prudent instant early wage dispersals in limited amounts. Such limits may include limited denominations with reasonable maximum and minimum amounts. The present system provides that all steps can be performed including all automated steps, non-automated steps, and communication at a reasonable internal cost to all organizations involved particularly the third party, to ensure any service fee the system provides for the third party which may be agreed to be deducted from net pay and paid to the third party is low enough to ensure the dispersal still creates value for the worker but also provides a sustainable system for all participants.

Further, where requested to do so, the system facilitates the third party to make dispersals not to the third party bank account or other financial service in the control of the worker, but rather as payments against the bills, loans and debts (creditors) of workers wanting to utilize accrued earnings—based early wage dispersals for that purpose. Further, the system may facilitate the application of dispersals against ongoing costs of discretionary goods and services such as investing in savings and investment financial securities usually by way of providing third party investment advisors with funds for the worker's accounts.

Further the system may facilitate means whereby the worker designates recipients of dispersals in advance to be repeated automatically within pay cycles or for each pay cycle.

Further, the system may detect lower than usual accrued earnings within a given portion of a given pay cycle, and may invite the worker by communication to the worker the worker may respond to, to modify pre-set dispersal instructions to instead have a more significant portion of dispersals sent to creditors who provide necessaries of life and a smaller proportion to providers of discretionary goods and services. Further, such may be automated to revise the proportion automatically.

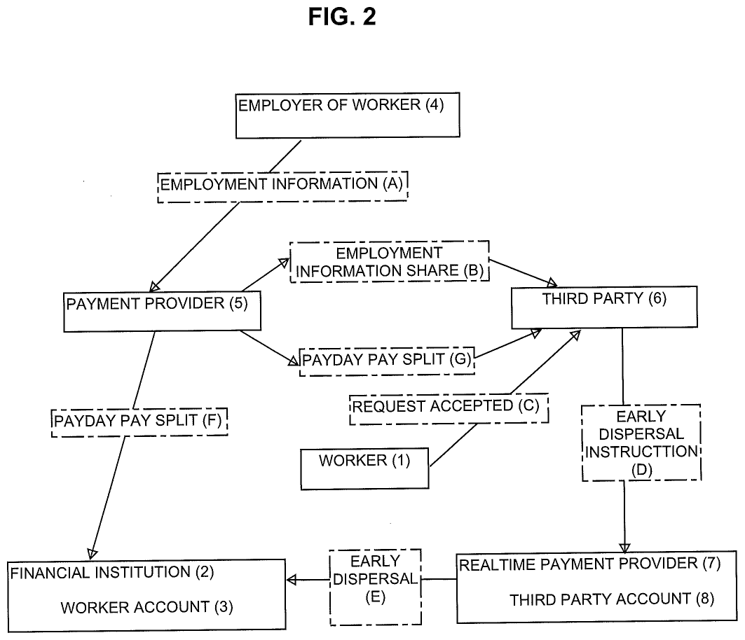

Referring now to FIG. 2, a system for on-demand, instant, early wage dispersals against accrued earnings in accordance with a preferred embodiment of the present invention provides a useful improvement over usual early wage or accrued earnings dispersals which are not always possible for wage earners, salaried workers or contractors.

The system of the present invention avoids the negative aspects of Worker 1 requesting earlier dispersals of pay from their Employer 4 (or if they are a contractor, of their principal), and of requesting them frequently including more than once in a given pay period. Payday loans which are not payments against accrued wages but rather are a kind of loan have unattractive aspects including high interest rates and other costs. The present invention avoids all these aspects of payday loans.

The system of the present invention provides Third Party 6 whose funds are used to facilitate the dispersals, avoiding all these aspects of payday loans and employer advances. Further, unlike other systems for dispersals, the present invention provides Real Time Payment Provider 7 which accesses the payment rail funds conveyancing system, for the funds to be dispersed instantly. Further the system provides that Payment Provider 5 be notified of the dispersals in a given pay cycle and to, on payday, cause the third party 6 to be reimbursed on payday or on such later date convenient.

Further, most workers 1 use a mobile phone and may use a mobile computing device such as a tablet computer. Such mobile phones utilize special software programs designed just for mobile computing devices and especially mobile phones, known as telephone application programs, mobile software applications or just “apps”. There are many financial apps. Online financial account or “banking” software programs and apps, are common. The present invention takes advantage of workers' ability to access financial software programs over the internet and by uploading software to their personal use computing devices.

Payroll software products of payroll software providers 5, which interact with employer or contractor of worker 4 and receive employer or contractor 4 historical and current pay information, as well as interact with worker 1, are typically available to software providers 5 by way of a software license to payroll providers 5. Application Program Interface software programs (“API's”) make it possible for third party financial organizations (third parties 6) to offer new and improved financial services in relation to on-demand earnings dispersals against accrued worker 1 earnings, by allowing third parties 6 to integrate with worker 1 employment information A (which may consist of the date worker first worked for employer 4, significant leaves and absence history, hourly wage, monthly pay or contract payment rates, current status with employer 4, hours or days worked in the present pay period, and other relevant employment information B. Such employment information may be supplemented by worker 1 who may input information in a system therefore, provided by either or both of the employers 4, the payment provider 5 or the third party 6. As a non-limiting example the worker 1 may provide hours worked in the recent days up to and including the date they make a Request or Accept an Early Dispersal D via obtaining access the system for an early dispersal D.

In the present invention the system provides means whereby workers 1 may initiate and receive the early wage dispersal services of third parties 6 through online connections. Such means may be via access to websites, or the system may provide mobile apps that connect through usual computer networks available and used by payroll providers 5 and third party 6 computer systems. System may provide access such that worker 1 accesses same through the same facility as used by worker to access payroll provide 5-hosted pay information (payday payroll deductions of a given worker 1, their past pay and past deductions, and the like). Workers 1 can connect to seek early wage dispersal services utilizing such same facilities, seamlessly.

Some workers 1 have worker bank accounts 3 and account-related debit cards. Some do not have bank accounts; rather they may be paid by check and cash checks for spending money. They may use stored-value cards, payment cards and e-wallet accounts. Still, the within invention can function notwithstanding such variations on personal spending vehicles and still provide benefits. It is adaptable to variations of spending vehicles workers may utilize and which may develop in the future.

Therefore the system of the present invention must provide means for third party 6 companies to provide services and operate in systems where they may consider the most relevant, current employment information and history, where the prudent amount of funds to disperse may be calculated immediately upon request for same, where the dispersals are dispersed instantly, where the worker 1 receives them instantly, where this service is provided for a fee, and where the third party 6 is reliably and consistently reimbursed all so as to make the system sustainable. To do this embodiments of the present invention provide a system whereby employment information held by payment providers 5 is available in real time by and to third parties 6. System provides that payment providers 5 and third parties 6 tightly integrate their payroll (and employment information) systems with their dispersal systems. The system provides real time payment providers 8 who can convey funds to bank accounts and bank accounts with debit cards associated with them, instantly. The system provides that third parties 6 may utilize the deposit account services of real time payment providers. The system of the present invention provides a means for third parties 6 to work with payment providers 5 of contractors as a kind of employer 4 and as such the system is robust and may operate in a variety of work circumstances.

Further referring to FIG. 2, a flow diagram shows a system by which worker 1, third parties 6, payment providers 5, employers 4 and real time payment providers (RTPP) 7 can interact directly or indirectly with a network or system to utilize one or more services offered.

In FIG. 2, the worker 1 has worked and has accrued earnings that may be accrued wages. FIG. 2 provides a system by which the worker 1 may receive early accrued earnings dispersals funded by a third party 6.

Also, worker 1 and their financial institution 2 have set up an account 3 to receive wage, salary or contract payments, pay bills, etc. Such account 3 may be connected to a debit card.

Employer 4 will have shared worker 1 employment information A with the payment provider 5 the employer 4 uses to handle employer 4 payroll.

Third party 6 financial organization has integrated its computers, software and wage dispersal-processing systems with payment provider's 5 payroll systems and can share employment information data B for worker 1 which data includes the employment information pertaining to worker 1 shared by employer 4 with the payment provider 5. Third party 6 and payment provider 5 have entered into agreements for this integration of systems and for the repayment to third party 6 of monies including early accrued earnings dispersals E third party 6 disperses to worker 1 on account of accrued earnings in a given pay period.

Worker 1 and third party 6 enter into an agreement for third party to, upon considering a worker 1 request for same, pay early accrued earnings dispersals to worker 1 based on accrued earnings of worker 1 in a given pay period based on worker 1 connecting to an automated system which may be access to an online database of the payment provider 5 (the same database of payment provider 5 that contains past pay, pay deductions and other relevant pay information the payment provider 5 typically provides worker 1). System may provide that third party 6 automated request evaluation systems automatically and instantly, through tight integration with payment provider 5 payroll system and with the employment information available therein, verify current employment status, consider various earnings information, parameters and factors, and determine a maximum amount able to be dispersed. System provides that third party 6 automatically provides worker 1 notice of that maximum amount of funds they may choose to receive for the particular early wage dispersal. System provides that worker 1 may indicate the amount within that maximum they desire to receive as an early wage dispersal, which may be a sum above a minimum amount, and may be the less than their then-accrued earnings. Such maximum amount may be a one-time maximum in the sense of a maximum for that dispersal or a maximum dispersal for that date. There may be a minimum time lag between dispersals such as a calendar day or such as 24 hours. The system may provide that where a fee for a dispersal is required to be paid to the third party 6, the same fee will be required, regardless of the amount of the dispersal.

Advantageously to the worker 1, the system both automatically and instantly confirms the amount the worker is seeking and facilitates worker 1 receiving funds through the services of a real-time-payment provider (RTPP) 7. In the embodiment shown in FIG. 2, as worker 1 can have provided the third party 6 with information any minimum banking information such as debit card information or email that would enable the worker 1 to receive funds into such accounts. The present system provides can then instruct the RTPP 7, to dispense funds to the worker's 1 account. System provides that such funds may be taken from an account 8 of the third party 6 held by the RTPP 7 such dispensing to be using the real time payment rails. RTPP 7 dispenses the early wage dispersal R into the worker account 3. Third party 6 informs payment provider 5 of the amount of the wage dispersal(s), and any fee or amount(s) third party 6 and worker 1 have agreed third party 6 will receive for the steps taken by third party 6.

Third party 6 provides information including the amount of the early wage dispersals dispersed to the worker 1 to the payment provider 5, and under the agreement payment provider 5 retains and calculates a total of early pay dispersals and any fees payable to the third party 7 for system dispersals to that worker 1 for that pay period.

Prior to payday, employer 4 of worker 1 has provided payment provider 5 with payroll funds which include the pay of the worker 1 and pay of other workers. On payday, payment provider 5 splits the out funds equal to the total of early wage dispersal(s) in that pay period, and fees if any from the worker's 1 net pay due the worker 1 that present payday and transfers same to an account controlled by third party 6. Alternatively, an aggregate repayment to the third party is provided by the payment provider 5 equivalent to most or all workers who have used the system for early dispersals over that payment period.

Third party 6 provides funds to RTPP 7 in advance of any dispersal, sufficient to permit there to be funds for instantaneous dispensing.

The system provides sufficient fees to allow the third party 6 to cover its internal costs including any costs of capital to fund the RTPP 7 account, and be able to perform this service for the worker 1 on an ongoing basis for the long term.

The present embodiment of the system of this invention may provide simple, reduced variations of parameters within the system. It may set early dispersal minimums and maximums, it may set an amount which any early dispersal must be a multiple of, it may set a minimum period of time before another advance after a first early dispersal can be made within a given pay cycle, and it may set a maximum amount of total advances which may be funded in a given pay cycle, and a maximum number of dispersals in a given pay cycle.

In a variation of this embodiment, as the Real time payment provider 7 can fund early dispersals into an account associated with a debit card only or most easily, the system may provide that it only funds early dispersals received by worker 1 in a financial account 3 that is associated with a debit card.

In a non-limiting example the system may provide that worker 1 may receive a minimum of $50, a maximum of $200 as any given early dispersal. The fee for any dispersal, regardless of amount may be $5. The maximum of all dispersals in a given pay cycle may be $1,000. The system may provide that the worker is unable to receive a dispersal until the next day after, or until the passage of 24 hours, after a first dispersal. The worker may be a limited of 5 dispersals in a given pay cycle, or a limit may be set based on available funds as a percentage of net accrued earnings.

In an alternate embodiment, the system may apply a monthly subscription fee to the worker for use of the system, said monthly subscription fee covering a predetermined number of dispersal requests per month and a maximum dispersal amount per transaction and/or per month.

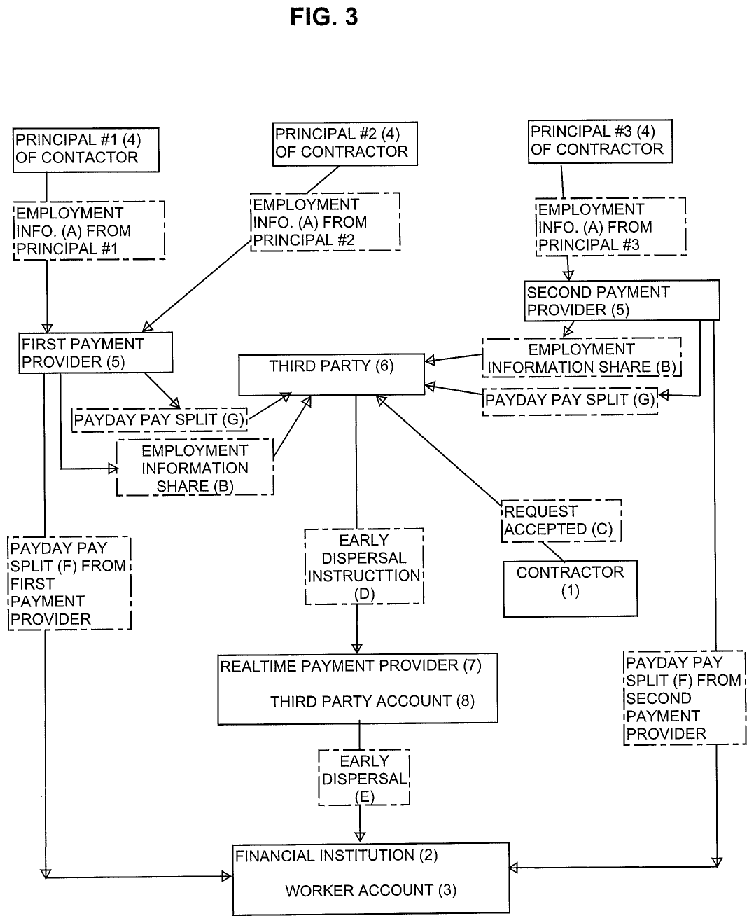

FIG. 3 is a flowchart that describes the system of the embodiment of FIG. 2 and showing the system may include additional employers who may be principals (and workers may be contractors). Two or more employers may share a single payment provider. Thus there may be one or several payment providers 5, and whereso, the system may provide a worker 1 who is a contractor. Worker 1 may work for several employers 4, who are principals of the worker 1 who pay the worker 1 per load carried from a directed location to another. Whereso, the system may provide a separate payment provider 5 for each worker 1 although in some variations of the system, the same payment provider may provide payroll services for both employers.

FIG. 3 shows that each payroll provider 5 (1) and 5 (2) is tightly integrated with the third party 6, for sharing of relevant employment information used by third party 6.

The system of this embodiment provides that at the time of a request, third party may calculate accrued earnings of worker 1 respecting one or more employers 4, and may provide an earnings dispersal based on only the accrued earnings of worker 1 with respect to one employer 4. Alternatively third party 6 may calculate accrued earnings of worker 1 with respect to both employers 4. Alternatively third party 6 may have already generated and stored for any future request a current calculation of accrued earnings of worker 1 with respect to one or both employers 4.

In this embodiment, where employees 1 are contractors, third party receives employment information sufficient to be informed what jobs are completed, what jobs have reached completion to a stage sufficient to entitle the worker 1 to be entitled to be paid and to conclude whereso, there are accrued earnings, and what jobs have been worked on but there is no accrued earnings respecting them. A non-limiting example of employment information used by system of this variation is whether an invoice, time sheet, ticket, field ticket or job completion form.

Upon third party 6 considering employment information it may cause RTPP 7 to fund an advance against accrued earnings to worker 1 in the usual fashion. Third party 6 may give a notice of having done so to one or both payment providers and such notice may be in the full amount of the advance. Where such notice is given to both payment providers, it may provide an amount that is a portion of the advance and a portion of the fee if any.

The system of this embodiment provides that repayment of the advance and fee if any is performed in the same fashion as in the original [first] embodiment, namely that upon payday, the payment provider 5 provides funds to the third party 6 equal to the amount of the notice.

As will be appreciated by a person of skill in the art having an understanding of the invention of the present embodiment, any variation of amounts of both employers 4 and payment providers 5 can be accommodated by this system.

As a non-limiting example a worker 1 may receive an overall job whereby worker is directed by employer 1 to drive a loaded truck from point A to point B and return unloaded. Employer 1 and worker 1 may agree that worker will be paid $500 to drive the truck from A to B, and $400 to return to A, and they may agree the whole will be payable in total upon having completed both trips. Upon having driven the loaded truck from A to B, employer 4, or worker 1, will cause worker 1 employment information to show having completed such job. There may be a ticket or job performance document created to make a record of same for use in functions beyond the ambit of the system here described. But, having access to such employment information, and there being a means for worker to request an advance against accrued earnings, upon the ticket being completed and recorded, third party financial information system calculates worker's accrued earnings so to include such ticket. Upon worker 1 making an inquiry and learning of the amount of accrued earnings record to their credit, and upon being advised the minimum and maximum amount they may receive in the form of an advance, worker may request, and third party may cause RTPP to advance a sum which may be $200, which sum is funded to worker account 3 using RTPP and funds in third party 6 account held by RTPP, and worker 1 may access such amount instantly, thereby becoming able to purchase goods and services right away such as fuel for his truck or food for personal consumption.

The system may provide for a fee to be payable to the third party 6 for the steps it takes. Such fee may, for example, be $5. Regardless, third party 6 advises the payment provider 5 related to the employer 4 for whom worker 1 transported the load, of the amount of the advance ($200) and the fee which may be $5. On the date worker 1 is paid for driving both trips and is otherwise owed $900, payment provider 5 will split such sum into two parts and pay the worker 1 $900 less $205, and will fund to the third party 6 the sum of $205.

Similarly in this non-limiting example, the worker may seek a further advance. Third party 6 may make available or provide ongoing calculations and information to worker 1, of what accrued earnings exist on account of the portion of the overall job. In the non-limiting example, if the fee for the first advance was $5, and the advance was $200, accrued earnings will still exist (the remaining portion of the $500 less the $205 will be accrued earnings). Worker may access that information at any time, or be advised of that, and also of the minimum and maximum amount they may request.

Worker may request $150. Such may be funded in the same manner, with the same notice and same repayment process as system provided for the first advance. Such may be prior to pay day, and may be prior to worker 1 driving the unloaded truck from B to A. System may provide that worker 1 may only request one advance per calendar day, or per 24 hours. However, in this non-limiting example if worker 1 requested a first early dispersal of $200, and another of $150 on a timely basis, and such were dispersed, and if fees of $5 were established for each early dispersal, then on payday, again assuming worker 1 has driven the load from A to B and the truck, unloaded from B to A, third party 5 performs a different split and pays the worker $900 less $360, and funds $360 to the third party.

In the non-limiting example, accrued earnings may still exist prior to worker 1 driving the unloaded truck from B to A, and may exist in the amount of $140. Same may further accumulate upon the worker 1 driving the truck from B to A (unloaded). Then, the worker 1 will have, upon a ticket being issued for such portion of the overall job, accrued earnings of $540. At such time, worker 1 may yet be unpaid and waiting for some days before payday. Employer 4 may only pay truck drivers once a month, or twice. If worker 1 wishes a third early dispersal of accrued earnings of $200 before payday, the system provides means as described and as would be understood, for them to be so paid, before payday, and for the exchange of information and for the payment by the payment provider of remaining pay F on payday, and for the payment of early dispersals and fees G to the third party 6, on pay day. Worker may drive trucks for several trucking firms who may use different pay providers. As would be understood the system of the embodiment of FIG. 3 adapts to provide the third party to calculate accrued earnings established by worker 1 with all employers 4, and to rely on, and give notice to, any number or combination of payment providers 5 of employers 4 to cause repayment of early dispersals on relevant next paydays. The system is adaptable to each employer having a different payday if that is the case as, the third party has up to date and real time, current employment information from each payment provider and has certainty of accrued earnings, when pay days fall on the calendar and other relevant information.

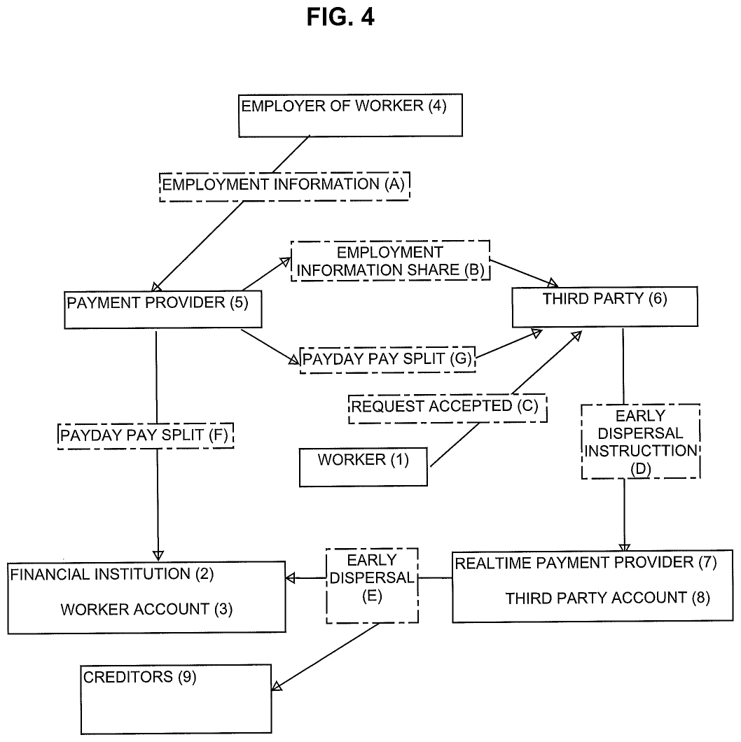

FIG. 4 shows a variation of the system which operates to cause funding of advances to be received by organizations associated with the worker 1 who may be creditors of the worker 1, and with the variation thereof where the worker 1 has pre-authorized the third party 6 to fund such organizations with set amounts and on regular cycles that may be determined with reference to pay cycles of the worker 1.

In this variation, and in particular where a significant percent of the worker-associated organizations as compared to all of them, are the subject of pre-authorized fundings, the third party 6 is, unlike any other financial organization known in the art, uniquely able to understand the cash flow of worker 1.

As a non-limiting example worker 1 may be a salaried employee of an employer 4, with an entitlement to receive quarterly bonus payments as additional earnings, which may be performance related. It may be regardless, such bonuses are usual in times when the goods or services of the employer 4 of worker 1 is enjoying a strong demand and high prices for the goods and services it provides to its relevant consumers.

However, the worker 1 may have a history of earning the same amount for a long period of time. Further as an aspect of this example, worker 1 may have pre-authorized all if their usual payments required for their necessaries of life such as their mortgage payment, their insurance payments (household, medical, vehicle and any other), their utility payments (heating fuel, electricity, municipal services), their phone, home and mobile computing device and related payments, and may have pre-authorized some discretionary payments that occur on a regular basis (funding into an investment account in their name with a financial investment firm).

In this variation of the system, the system may provide that the third party monitor the amount of accrued earnings at a single time, continuously, or on several occasions in a given time period for example in a given month. Whereso, system may provide that worker 1 and third party 6 arrange to ensure pre-authorized fundings occur using advances of accrued earnings such to be paid to third parties as described; but, in the event accrued earnings accrue more slowly or significantly less amount at any given point in time, worker 1 and third party 6 arrange the payment to the investment organization be interrupted or reduced until such time as usual accrued earnings are accumulating in favor of the worker 1.

In a variation of the system, there is a variation of the pre-authorized payment system of the present invention. In this variation, the fee payable for an advance is nil, a negative number, or is very low; and, the system provides that a particular worker-associated organization the third party 6 is pre-authorized to provide early dispersal funds to, receives such funds frequently. Frequently may be daily, and the early dispersals may be small amounts. Worker-associated organization receiving early dispersals of this variation of the system may be a financial institution that has loaned the worker money under or secured by, a residential property mortgage advanced for the purchase of the worker's home. In this variation of the system, the mortgage holding institution is amenable to receiving mortgage payments frequently and in the non-limiting example of the system providing daily dispersals, daily. Alternatively, the mortgage holder may receive mortgage payments on every normal work day of the calendar year, and not on weekends, statutory holidays, or any other days not considered normal work days in a given calendar year, and, the system may provide dispersals on those work days.

Advantages of this variation include the reduction of mortgage interest (portion of the mortgage payment that is payable by the worker 1 to the mortgage-holding financial organization for the worker's use of the amount advanced under the mortgage). Such reduction may be likely due to the faster repayment as compared to mortgages repaid monthly, bi-monthly, or weekly. The system may provide there be no fee for advances of accrued earnings funded to such financial organizations connected to the worker due to such financial institutions providing the third party with a payment or financial benefit of a kind, in consideration of the expectation that it is more likely that the funds they advanced the worker 1 will more likely be repaid timely and at all, and that the advanced funds will be repaid more quickly, in turn allowing the institution the chance to experience fewer late mortgage payments and fewer defaults, and be able to receive funds earlier and re-advance more funds.

In a variation of this embodiment third party is a financial organization holding a mortgage and it holds such loan account separately, and upon an early dispersal of accrued earnings, transfers a credit to the mortgage account which is debited on pay day, or, it holds actual funds in a separate account for such early dispersals used for this purpose and transfers such funds from that account, to the mortgage account. As will be understood by a person of skill any number of accounting variations will suffice to present the advantages of the present invention. Further, instead of a mortgage holding organization, recipient of frequent early dispersals may be any other creditor of worker so prepared to so accept frequent payments. Further, the frequency of payments may be lower than daily, or in some cases higher, without affecting the overall structure of the variation of the present invention all as will be appreciated by a person of skill in the art to which the present inventions pertain.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

What is claimed is:

1. A system for providing automated early dispersals of accrued but unpaid wages to a worker who has accrued wages from one or more employers, said system comprising:
a. one or more customizable applications associated with the system;
b. a communications platform in the form of an application programming interface for integrating and communicating in real-time with one or more databases containing employment and accrued wages information about the worker;
c. a processor;
d. a memory that stores instructions from each of said one or more customizable applications, wherein said instructions, when executed by the processor, cause the processor to perform operations comprising:
i. receiving a request for an early dispersal of wages from the worker;
ii. communicating in real-time with any one or more of the one or more databases via the applications programming interface to collect employment and accrued wages information of the worker, instantly upon receiving the request;
iii. automatically determining an early dispersal amount based on employment and accrued wages information and meeting one or more pre-determined requirements;
iv. instantly dispersing the early dispersal amount to the worker upon processing the early wage amount;
v. instantly informing the worker of the determined early dispersal amount; and
vi. collecting, at a time of wage payment, the early dispersal amount and a fee for service.

2. The system of claim 1 wherein a third party controls the system and collects the early dispersal amount and fee for service.

3. The system of claim 2 wherein instant dispersal of the early dispersal amount comprises
a) instructing a real time payment provider to instantly disperse the early dispersal amount to the worker from funds supplied by the third party in a third party account accessible by the real-time payment provider.

4. The system of claim 2, wherein the one or more databases of worker employment and accrued wages information are held by one or more payment providers, each of said one or more payment providers receiving worker employment information from either one of: said worker and one or more of the one or more employers.

5. The system of claim 4, wherein collection of the early dispersal amount and fee for services by the third party comprises dispersal of the early dispersal amount and fee for services by any one or more of the one or more payment providers at the time of wage payment.

6. The system of claim 3, wherein dispersing of the early dispersal amount by the real-time payment provider is to an account of the worker at a financial institution.

7. The system of claim 6, wherein the worker's account is associated with a debit card.

8. The system of claim 1, wherein the system is capable of receiving multiple early dispersal requests from the worker and of dispersing multiple early dispersal amounts between two consecutive paydays.

9. The system of claim 1, wherein receiving an early dispersal request comprises the system storing one or more regular early dispersal request instructions that have been provided in advance by the worker, and executing steps ii to v automatically at a predetermined date.

10. The system of claim 1, wherein the one or more applications of the system are accessible by the worker to access wage and early dispersal information and history of the worker and wherein the system further comprises an interface by which the worker can access the one or more applications.

11. The system of claim 10, wherein the one more applications accessible by the worker conducts a further step of inviting the worker to consider requesting an early dispersal.

12. A system for providing automated early dispersals of accrued but unpaid wages to a worker who has accrued wages from one or more employers, said system comprising:
a. one or more customizable applications associated with the system;
b. a communications platform in the form of an application programming interface for integrating and communicating in real-time with one or more databases containing employment and accrued wages information about the worker;
c. a processor;
d. a memory that stores instructions from each of said one or more customizable applications, wherein said instructions, when executed by the processor, cause the processor to perform operations comprising:
i. receiving a request for an early dispersal of wages from the worker;
ii. communicating in real-time with any one or more of the one or more database via the applications programming interface to collect employment and accrued wages information of the worker, instantly upon receiving the request;
iii. automatically determining an early dispersal amount based on employment and accrued wages information and meeting one or more pre-determined requirements;
iv. dispersing at least a portion of the early dispersal amount to one or more payees approved by the worker;
v. dispersing a remaining portion of the early dispersal amount to the worker;
vi. informing the worker of the determined early dispersal amount, the portion dispersed to the payee and the portion dispersed to the worker; and
vii. collecting, at a time of wage payment, the early dispersal amount and a fee for service.

13. The system of claim 12, wherein the at least portion of the early dispersal amount paid to a payee is determined and instructed by input from the worker.

14. The system of claim 13, wherein the approved payee is a creditor.

15. The system of claim 14, wherein the creditor is one or more suppliers of necessary services selected from the group consisting of a mortgage lender, a utility company, a vehicle finance company, a work tool and equipment finance company and a mobile phone provider.

16. The system of claim 15, wherein the creditor is one or more suppliers of discretionary goods and services selected from the group consisting of a financial savings and investment organization, a religious organization, a charity and a money transfer organization.

17. The system of claim 16, wherein an application of the system, via an interface with the worker can perform the step of:
a. informing the worker of a reduction in accrued earnings between consecutive paydays;
b. automatically determining which creditors can be sent early dispersals based on prioritization data and on early dispersal amounts determined to be available; and
c. informing the worker which prioritized creditors will be dispersed, and amounts.

18. The system of claim 17, wherein prioritization of approved creditors is providable by, modifiable by and overridable by the worker via the interface.

19. A method for providing automated early dispersals of accrued but unpaid wages to a worker who has accrued wages from one or more employers, said method comprising the steps of:
a. providing one or more customizable applications associated with the system, a communications platform in the form of an application programming interface for integrating with one or more databases containing employment and accrued wages information about the worker and a processor;
b. receiving a request for an early dispersal of wages from the worker;
c. communicating in real-time with any one or more of the one or more database via the applications programming interface to collect employment and accrued wages information of the worker, instantly upon receiving the request;
d. automatically determining an early dispersal amount based on employment and accrued wages information and meeting one or more pre-determined requirements;
e. instantly dispersing the early dispersal amount to the worker upon processing the early wage amount;
f. instantly informing the worker of the determined early dispersal amount; and
g. collecting, at a time of wage payment, the early dispersal amount and a fee for service.
